(19) United States
(12) Patent Application Publication
(10) Pub. No.: US 2009/0297076 A1
(43) Pub. Date: Dec. 3, 2009

(54) FLUID DYNAMIC BEARING DEVICE

(75) Inventors: Kazutoyo Murakami, Mie (JP); Masaki Egami, Mie (JP); Kenji Ito, Mie (JP); Isao Komori, Mie (JP); Mitsuo Sasabe, Mie (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi, Osaka (JP)

(21) Appl. No.: 12/063,174

(22) PCT Filed: Aug. 10, 2006
(86) PCT No.: PCT/JP2006/315859

§ 371 Date: Jun. 19, 2009

(30) Foreign Application Priority Data
Sep. 9, 2005 (JP) 2005-262660
Sep. 21, 2005 (JP) 2005-274474

(51) Int. Cl. F16C 32/06

(52) U.S. Cl. 384/100

(57) ABSTRACT

A hub portion of a fluid dynamic bearing device is formed from a resin composition in which polyphenylene sulfide (PPS) is employed as a base resin and with which carbon fibers are mixed. In this manner, the wear resistance and the conductivity can be improved. Alternatively, both portions of a stationary body and a rotating body of the fluid dynamic bearing device which portions face to each other through a bearing gap are formed from a resin composition in which polyphenylene sulfide (PPS) is employed as the base resin. In this manner, excellent wear resistance can be obtained.

### TECHNICAL FIELD

The present invention relates to a fluid dynamic bearing device. The fluid dynamic bearing device is suitable for a bearing device for a spindle motor of information devices including magnetic disk apparatus such as an HDD and an FDD, optical disc apparatus for a CD-ROM, a CD-R/RW, a DVD-ROM/RAM, and the like, and magneto-optical disc apparatus for an MD, an MO, and the like, a polygon scanner motor for a laser beam printer (LBP), and a compact motor for a color wheel of a projector or electric apparatus such as an axial flow fan.

### BACKGROUND ART

For the abovementioned various motors, speedup, reduction of cost, reduction of noise, and the like are required in addition to high rotational accuracy. One of the components determining these performance requirements is a bearing device which supports a spindle of the motor. In recent years, for such a bearing device, the use of a fluid dynamic bearing device having excellent characteristics for the above performance requirements has been contemplated, or such a fluid dynamic bearing device has actually been employed.

Such fluid dynamic bearings device are broadly categorized into what is provided with a dynamic pressure generating portion for generating dynamic pressure on a lubrication fluid in a bearing gap and what is not provided with any dynamic pressure generating portion, so-called cylindrical bearing.

As an example of the fluid dynamic bearing device, for example, a fluid dynamic bearing device employed in a spindle motor of a disk drive apparatus such as an HDD is described in Patent Document 1. This bearing device comprises a closed-end cylindrical housing, a bearing sleeve fixed to the inner periphery of the housing, and a shaft member inserted into the bearing sleeve and having a flange portion extending to the radially outward side. When the shaft member rotates, fluid dynamic pressure is generated in a radial bearing gap and a thrust bearing gap which gaps are formed between the shaft member and stationary members (such as the bearing sleeve and the housing), and the shaft member is supported in a non-contact manner through the fluid dynamic pressure.

In addition, a bearing device described in Patent Document 2 comprises a housing having a cylindrical inner peripheral surface, a bearing sleeve fixed to the inner periphery thereof, a shaft member inserted into the bearing sleeve, and a disk hub attached to the shaft member. When the shaft member rotates, fluid dynamic pressure is generated in a radial bearing gap formed between the shaft member and the bearing sleeve and in a thrust bearing gap formed between the disk hub and the housing, and the shaft member and the disk hub are supported in a non-contact manner through the fluid dynamic pressure.

### [Patent Document 1] Japanese Patent Laid-Open Publication No. 2000-291648

### [Patent Document 2] Japanese Patent Laid-Open Publication No. 2005-188552

### DISCLOSURE OF THE INVENTION

### Problems to be Solved by the Invention

In the abovementioned fluid dynamic bearing devices, efforts have been made to improve the machining accuracy and assembling accuracy of each component in order to ensure high bearing performance required as information devices grow increasingly sophisticated. On the other hand, the demands for cost reduction of such fluid dynamic bearing devices become even more stringent with the trend toward lower prices of the information devices.

In recent fluid dynamic bearing devices, in order to address the above requirements, it has been contemplated that resin is employed for stationary bodies (for example, a housing) and rotating bodies (for example, a shaft member and a disk hub) in the bearing device. On the other hand, in the fluid dynamic bearing devices, since temporary contact sliding is unavoidable between the rotating bodies and the stationary bodies facing each other through a bearing gap because of the structure of the fluid dynamic bearing devices, the components made of resin are likely to wear.

Accordingly, it is an object of the present invention to provide a fluid dynamic bearing device which has high durability and can be manufactured at low cost.

### Means for Solving the Problems

In order to solve the foregoing problems, the present invention provides a fluid dynamic bearing device which has a rotating body constituted by a shaft portion and a hub portion attached to the shaft portion integrally or separately and a stationary body having the shaft portion inserted thereinto and in which the rotating body is rotatably supported by an oil film formed in a bearing gap between the stationary body and the hub portion. The fluid dynamic bearing device is characterized in that at least part of the hub portion which part faces to the bearing gap is formed from a resin composition in which polyphenylene sulfide (PPS) is employed as a base resin and with which carbon fibers serving as a filler are mixed.

By forming at least part of the hub portion which part faces to the bearing gap from the resin composition, the cost and weight can be reduced as compared to the case in which the part is formed from metal. Furthermore, according to verification performed by the inventors, it has been revealed that high wear resistance is obtained by molding the hub portion from the resin composition containing PPS serving as the base resin. Furthermore, by mixing carbon fibers serving as a filler with this resin material, the strength and the wear resistance are further improved, and conductivity can be imparted thereto. Generally, resin is an insulating material. Therefore, if each of the components is formed of resin as described above, static electricity generated in the rotating body by friction with air is accumulated in the rotating body. Thus, a potential difference is likely to be generated between a magnetic disk and a magnetic head, and damage in peripheral devices is likely to occur due to discharge of the static electricity. In view of this, by allowing carbon fibers to be contained as a filler in the resin members, the electric continuity between the rotating side and the stationary side can be ensured to thereby resolve such a problem.

Preferably, the mixed amount of the carbon fibers in the resin is set within the range of 20 to 35 vol %. This is because, when the mixed amount of the carbon fibers exceeds 35 vol %, the fluidity of the resin material at the time of injection molding deteriorates, and thus a difficulty arises in molding of components. In addition, when the mixed amount is below 20 vol %, the strength required for the hub portion cannot be obtained.

Furthermore, the present invention provides a fluid dynamic bearing device which has a rotating body, a stationary body, and an oil film which is formed in a bearing gap between the rotating body and the stationary body and which supports the rotating body so as that the rotating body can rotate freely. The fluid dynamic bearing device is characterized in that at least parts of the rotating body and the stationary body which parts face to each other through the bearing gap are formed from a resin composition including PPS serving as a base resin.

By forming at least parts of the rotating body and the stationary body which parts face to each other through the bearing gap from the resin composition, the cost and weight can be reduced as compared to the case in which the portions are formed of metal. Furthermore, according to verification performed by the inventors, it has been revealed that high wear resistance is obtained by molding both the parts contact-sliding relative to each other from the resin composition containing PPS serving as the base resin.

When the abovementioned resin material contains carbon fibers as a filler, the strength and the wear resistance are improved, and conductivity can be imparted thereto.

In this case, preferably, the mixed amount of the carbon fibers in the resin is set within the range of 10 to 35 vol %. When the mixed amount of the carbon fibers exceeds 35 vol %, the fluidity of the resin material at the time of injection molding deteriorates, and thus a difficulty arises in molding of components. In addition, when the mixed amount is below 10 vol %, the effects obtained by mixing the carbon fibers cannot be obtained satisfactorily.

As the carbon fibers mixed in the resin composition as described above, PAN-based carbon fibers having excellent characteristics in terms of strength and elastic modulus may be employed.

Furthermore, when carbon fibers having an aspect ratio of 6.5 or more are employed as the carbon fibers mixed in the resin composition as described above, reinforcing effects, conducting effects, and the like are exerted more remarkably.

A motor having the abovementioned fluid dynamic bearing device, a rotor magnet, and a stator coil is excellent in wear resistance and has excellent characteristics in terms of durability and a rotation accuracy.

### ADVANTAGES OF THE INVENTION

According to the present invention, a fluid dynamic bearing device can be obtained which has high durability and can be manufactured at low cost.

### BEST MODE FOR CARRYING OUT THE INVENTION

Hereinafter, a first embodiment of the present invention will be described with reference to FIGS. 1 to 4.

FIG. 1 conceptually illustrates an example of a configuration of a spindle motor which is used for information devices and into which a fluid dynamic bearing device 1 according to the first embodiment of the present invention is incorporated. This spindle motor is employed in a disk drive apparatus such as an HDD. The spindle motor has: the fluid dynamic bearing device 1 in which a rotating body 3 having a shaft portion 2 is rotatably supported in a non-contacting manner; a stator coil 4a and a rotor magnet 4b which face to each other through a gap, for example, in the radial direction; and a motor bracket 5. The stator coil 4a is attached to the radially outward side of the motor bracket 5, and the rotor magnet 4b is attached to the outer periphery of the rotating body 3. A housing 7 of the fluid dynamic bearing device 1 is fixed to the inner periphery of the motor bracket 5. One or a plurality of disk-shaped information recording media (hereinafter simply referred to as disks), such as magnetic disks, are held in the rotating body 3 but will not be illustrated. In the spindle motor configured as above, when the stator coil 4a is energized, the rotor magnet 4b is rotated by an electromagnetic force generated between the stator coil 4a and the rotor magnet 4b. Together with this, the rotating body 3 and the disks held by the rotating body 3 are rotated integrally.

FIG. 2 illustrates the fluid dynamic bearing device 1. This fluid dynamic bearing device 1 is configured by a stationary body 6 and the rotating body 3 which rotates relative to the stationary body 6. The stationary body 6 has the housing 7 and a bearing sleeve 8 fixed to the housing 7, and the rotating body 3 has the shaft portion 2 and a hub portion 9 placed in an aperture side of the housing 7. In the following description, among apertures formed at both the axial ends of the housing 7, the side sealed by a lid member 10 is referred to as a lower side, and the side opposite to the sealed side is referred to as an upper side, for the convenience of the description.

The hub portion 9 is formed by injection molding a resin material after the insertion of the shaft portion 2 formed separately. The hub portion 9 is constituted by a disk portion 9a which covers the aperture side (the upper side) of the housing 7, a cylindrical portion 9b which extends downward in the axial direction from the outer periphery of the disk portion 9a, and a disk placing surface 9c and a rib portion 9d that are provided in the outer periphery of the cylindrical portion 9b. The disks which are not shown are externally fitted to the outer periphery of the disk portion 9a and are placed on the disk placing surface 9c. The disks are held by the hub portion 9 by means of suitable holding means (such as a clamper) not shown in the figure.

The shaft portion 2 is formed of a metal material such as stainless steel. In an outer peripheral surface 2a of the shaft portion 2, an annular groove 2c is formed in a portion to which the hub portion 9 is attached. The annular groove 2c functions to prevent the shaft portion 2 from disconnecting from the hub portion 9. A flange portion 20 formed of, for example, a metal material is fixed to the lower end of the shaft portion 2 by means of means such as screw connection.

The bearing sleeve 8 may be formed of a metal material such as an aluminum alloy or a copper alloy such as brass or may be formed of a porous body formed of sintered metal. In this embodiment, the bearing sleeve 8 is made of a sintered metal porous body having copper as a main component and is formed into a cylindrical shape.

In part or the whole of a cylindrical region of an inner peripheral surface 8a of the bearing sleeve 8, formed is a region in which a plurality of dynamic pressure generating grooves serving as a radial dynamic pressure generating portion are arranged. In this embodiment, for example, as shown in FIG. 3, two regions in which a plurality of dynamic pressure generating grooves 8a1 and 8a2, respectively, are arranged in a herringbone shape are formed in respective places separated in the axial direction. These dynamic pressure generating groove-formed regions serve as a radial bearing surface and face to the outer peripheral surface 2a of the shaft portion 2. When the rotating body 3 rotates, radial bearing gaps of first and second radial bearing portions R1 and R2 are formed between the dynamic pressure generating groove-formed regions and the outer peripheral surface 2a of the shaft portion 2, respectively (see FIG. 2).

In part or the whole of an annular region of a lower end surface 8c of the bearing sleeve 8, formed is in which, for example, a plurality of dynamic pressure generating grooves serving as a thrust pressure generation portion are arranged in a spiral shape, but these grooves are not illustrated. This dynamic pressure generating groove-formed region serves as a thrust bearing surface and faces to an upper end surface 20a of the flange portion 20. When the shaft portion 2 (the rotating body 3) rotates, a thrust bearing gap of a second thrust bearing portion T2 is formed between the dynamic pressure generating groove-formed region and the upper end surface 20a of the flange portion 20 (see FIG. 2).

The housing 7 is made of a metal material and formed into a cylindrical shape having openings at both the axial ends thereof, and the lower opening is sealed by the lid member 10. In part or the whole of an annular region of an upper end surface 7a of the housing 7, formed is a region in which, for example, a plurality of dynamic pressure generating grooves 7a1 serving as a thrust pressure generation portion are arranged in a spiral shape as shown in FIG. 4. The region in which the dynamic pressure generating grooves 7a1 are formed faces to a lower end surface 9a1 of the disk portion 9a of the hub portion 9 and serves as a thrust bearing surface. When the rotating body 3 rotates, a thrust bearing gap of a first thrust bearing portion T1 to be described later is formed between the lower end surface 9a1 and the region (see FIG. 2).

The lid member 10 which seals one end side of the housing 7 is formed of a metal material or a resin material and is fixed to a step portion 7b provided in the lower inner peripheral side of the housing 7. No particular limitation is imposed on the means for fixing. For example, means such as bonding (including loose bonding and press-fitting bonding), press-fitting, welding (for example, ultrasonic welding), or other welding (for example, laser welding) may be appropriately selected in accordance with the combination of materials, required assembly strength, hermeticity, and the like.

To an inner peripheral surface 7c of the housing 7, an outer peripheral surface 8b of the bearing sleeve 8 is fixed through appropriate means such as bonding (including loose bonding and press-fitting bonding), press-fitting, or welding.

A tapered sealing surface 7d having a diameter gradually increasing toward the upper side is formed in the outer periphery of the housing 7. This tapered sealing surface 7d and an inner peripheral surface 9b1 of the cylindrical portion 9b form therebetween an annular sealing space S having a radial dimension gradually decreasing from the lower side of the housing 7 toward the upper side. When the rotating body 3 rotates, this sealing space S is in communication with the radially outward side of the thrust bearing gap of the first thrust bearing portion T1.

A lubricating oil is filled inside the fluid dynamic bearing device 1, and the oil level of the lubricating oil is always maintained in the sealing space S. Various lubricating oils can be employed. In particular, a low evaporation rate and low viscosity characteristics are required for a lubricating oil provided to a fluid bearing devise for a disk driving device such as an HDD. For example, ester-based lubricating oils such as dioctyl sebacate (DOS) and dioctyl azelate (DOZ) are suitable for the purpose.

As mentioned above, the hub portion 9 is molded from a resin material, and the lower end surface 9a1 of the disk portion 9a of the hub portion 9 faces to the thrust bearing surface of the upper end surface 7a of the housing 7 through the thrust bearing gap of the first thrust bearing portion T1. Since contact sliding occurs between these surfaces facing through the bearing gap upon starting and stopping a motor or in other situations, the wear of the sliding surfaces is unavoidable. In particular, when the housing 7 is made of metal as in the present embodiment, the wear of the hub portion 9 made of resin proceeds to cause the gap width of the thrust bearing gap of the thrust bearing portion T1 to be excessively large, and therefore the supporting force by the thrust bearing portion T1 of the bearing is likely to be lowered. Therefore, a resin material having high wear resistance must be selected for the hub portion 9.

Furthermore, the resin material for the hub portion 9 must have oil resistance to lubrication oil, and the amount of outgas generation and the amount of water absorption must be suppressed to low levels in the resin material during use. In addition, high heat resistance is also required in view of a temperature change under an atmosphere during use.

If the base resin of a resin composition forming the hub portion 9 is a crystalline resin such as polyphenylene sulfide (PPS), a liquid crystal polymer (LCP), or a polyether ether ketone (PEEK), the abovementioned conditions (the wear resistance, oil resistance, low outgas characteristics, low water absorbance, and heat resistance) are satisfied. Of these, PPS is available at low cost compared to the other crystalline resins and is a resin excellent in flowability (melt viscosity) during molding. Thus, PPS is particularly suitable for the base resin of the hub portion 9.

Generally, PPS is produced through a polycondensation reaction between sodium sulfide and paradichlorobenzene and thus simultaneously contains sodium chloride as a by-product. When this sodium chloride is dissolved into a lubricating fluid (for example, a lubricating oil) filled inside the bearing, the dissolved sodium chloride causes the deterioration of the lubricating oil and the change in viscosity, and therefore the performance of the bearing is likely to be lowered. Furthermore, when the bearing is for use in an HDD, such a metal element precipitates on a head of a hard disk to cause failure of the hard disk.

In order to prevent the abovementioned problems, PPS must be washed with an appropriate solvent. Any solvent may be employed as the solvent for washing so long as it has a relative dielectric constant of at least 10 or more and preferably 20 or more. A solvent having a relative dielectric constant of 50 or more is more preferable. Furthermore, in view of environmental factors, for example, water (relative dielectric constant: 80) is preferable, and ultrapure water is particularly preferable. By washing with such a solvent, Na in the terminal group of PPS is mainly removed. Therefore, the content of Na in PPS can be reduced (to, for example, 2000 ppm or less), and the dissolution of Na into lubricating oil can be prevented. In addition, by removing Na in the terminal group, an advantage is obtained in that the crystallization rate is enhanced.

The PPSs can be broadly classified into a crosslinked type PPS, a semi-linear type PPS, and a linear type PPS according to the structure. Any of the PPSs can be employed as the base resin for the resin composition of the hub portion 9 so long as the content of Na is 2000 ppm or less, more preferably 1000 ppm or less, and most preferably 500 ppm or less. Of these, many of the linear type PPSs satisfy this condition. By employing such a resin composition, the amount of Na ions dissolved into a lubricating oil can be suppressed, and the occurrence of precipitation of Na on the surface of the fluid dynamic bearing device 1, a disk held by the rotating body 3, or a disk head (not shown) can be prevented more reliably.

When a reinforcing filler (such as carbon fibers or glass fibers) is mixed with a resin composition employing the abovementioned PPS as the base polymer, the strength of the hub portion 9 can be increased, and the change of the dimension of the hub portion 9 with temperature change can be suppressed to thereby obtain high dimensional stability. Consequently, the bearing gap during use can be controlled with high accuracy. Among the reinforcing fillers, the carbon fibers are the most preferable reinforcing filler since these have the following characteristics:

(1) The tensile strength of the fibers themselves is high.
(2) The adhesive properties to the base material are high, and the strength of the resin composition can be effectively enhanced by the addition of a small amount of the fibers.
(3) Since the specific gravity is low and the strength is high, the weight reduction of the hub portion 9 is possible.
(4) Since the dissolution of ions does not occur, the abovementioned problem caused by the ion dissolution does not arise (for example, since the glass fibers, which are a fiber-like reinforcing agent similar to the carbon fibers, are a silica compound, a trace amount of silicon is likely to be dissolved with time).
(5) The high conductivity possessed by the carbon fibers emerges, and thus sufficient conductivity (for example, 1.0×10⁶ Ω·cm or less in terms of volume resistivity) can be imparted to the hub portion 9. In this manner, static electricity accumulated in a disk during use can be dissipated through the rotating body 3 and the stationary body 6 to a grounding side member (such as the motor bracket 5).

Various carbon fibers such as PAN-based carbon fibers, Pitch-based carbon fibers, and carbon fibers by vapor deposition can be employed as the carbon fibers. However, carbon fibers having relatively high tensile strength (preferably 3000 MPa or more) are preferable in terms of reinforcing effects. In particular, as carbon fibers also having high conductivity, the PAN-based carbon fibers are preferable.

As these PAN-based carbon fibers, carbon fibers having dimensions within the ranges described below may be employed.

(1) When a molten resin is kneaded and injection molded, the carbon fibers are cut, resulting in reduction of the fiber length. As the reduction of the fiber length proceeds, the reduction of the strength, the conductivity, and the like becomes significant, and thus difficulties arise in satisfying the required characteristics. Therefore, as the carbon fibers mixed with the resin, it is preferable that relatively long fibers be employed for allowing the breakage of the fibers during molding. Specifically, carbon fibers having an average fiber length of 100 μm or more (preferably 1 mm or more) are desirably employed.
(2) On the other hand, in some cases, in an injection molding step, the resin cured in a metal mold is removed and re-melted for reuse (recycle use) by kneading with a virgin resin composition. In this case, part of the fibers are repeatedly recycled. Therefore, when the initial length of the fibers in the resin is too long, the length of the fibers becomes significantly shorter than the initial fiber length because of the cutting associated with the recycling to cause significant changes in the characteristics of the resin composition (such as the reduction of the melt viscosity). In particular, the reduction of melt viscosity is an important characteristic affecting the dimensional accuracy of a product. In order to keep such characteristic changes to a minimum, fibers having a length shorter than a certain length are preferable. Specifically, it is desirable that the average fiber length be 500 μm or less (preferably 300 μm or less).

The selection of the fiber length of the carbon fibers as described above may be determined based on what kind of resin composition is employed in an actual injection molding step. For example, when only a virgin resin composition is employed, or when a recycled resin composition is employed and mixed and the ratio of a virgin resin composition is high, it is preferable to employ carbon fibers having a dimension within the range described in (1) above in terms of suppressing the reduction of the strength, the conductivity, and the like and of the capability of reducing the mixing amount of the carbon fibers. On the other hand, when the ratio of use of a recycled resin composition is high, it is desirable to employ carbon fibers having a dimension within the range described in (2) above in terms of suppressing the changes of the characteristics of the resin composition associated with the recycling.

In any of the carbon fibers of (1) and (2), the longer the fiber length is, the better the connectivity among the fibers becomes and thus the more the reinforcing effects and the conduction effects are enhanced. Furthermore, the smaller the diameter of the fibers is, the more the mixing number thereof is. Therefore, it is more effective for making the quality of product uniform. Therefore, the larger the aspect ratio of the carbon fibers is, the more preferable it is. Specifically, the aspect ratio is desirably 6.5 or more. Furthermore, it is suitable that the average fiber diameter of the carbon fiber is 5 to 20 μm if workability and availability are taken into account.

In order to fully exert the reinforcing effects, the static electricity removal effects, and the like due to the abovementioned carbon fibers, it is preferable that the filling amount of the carbon fibers into the base resin be 20 to 35 vol %. This is because, when the filling amount of the carbon fibers is less than 20 vol %, the strength, in particular the tensile strength, required for mounting a disk on the hub portion 9 is not obtained. When the filling amount exceeds 35 vol %, the moldability of the hub portion 9 deteriorates, and thus a difficulty arises in obtaining high dimensional accuracy.

Preferably, in order to fill a cavity with the molten resin with high accuracy, the melt viscosity of the resin composition formed by mixing the carbon fibers with the abovementioned base resin (PPS) is suppressed to 500 Pa·s or less at a share rate of 1000 s⁻¹ and the resin temperature at the time of injection molding the resin. Therefore, preferably, in order to compensate for the increase in the viscosity due to the filling of various fillers such as the carbon fibers, the melt viscosity of the base resin (PPS) is desirably lower than the abovementioned viscosity and more desirably 300 Pa·s or less under the above conditions.

As described above, by forming the hub portion 9 from the resin composition, the production cost is reduced as compared to the case in which the hub portion is formed from a metal material, and the impact resistance can be improved due to the reduction of weight. Furthermore, by employing PPS for the base resin of the resin composition, the wear resistance is improved, and the wear caused by the contact sliding with the stationary body 6 (the thrust bearing surface of the upper end surface 7a of the housing 7) upon starting and stopping the bearing device or in other situations can be suppressed. Moreover, by mixing an appropriate amount of the carbon fibers in accordance with intended applications, the hub portion 9 excellent in mechanical strength, static electricity removal characteristics, and dimensional stability can be obtained.

In this embodiment, the rotating body 3 is formed by integrally molding using the resin after the shaft portion 2 made of metal is inserted into the hub portion 9. During actual use of the bearing, the resin material is expanded or shrunk due to the rise or fall of ambient temperature. At this time, when the difference in linear expansion coefficient between an insert member (the shaft portion 2) and a resin portion (the hub portion 9) is excessively large, peeling and displacement are likely to occur at the bonding surface between the insert member and the resin portion.

Furthermore, a disk is externally fitted to the outer periphery of the disk portion 9a of the hub portion 9 and is placed on the disk placing surface 9c. When the difference in linear expansion coefficient between the hub portion 9 and the disk is excessively large, the gap between the bore of the disk and the outer periphery of the disk portion 9a of the hub portion 9 becomes a negative gap due to a temperature change during use of the bearing. Thus, since unnecessary stresses are applied to the disk, distortion is likely to occur.

In order to avoid the abovementioned problems, the resin material employed in the hub portion must be selected such that the linear expansion coefficient thereof falls within the range of the above two limitations (the limitation due to the insert member and the limitation due to the disk).

In the fluid dynamic bearing device 1 having the above configuration, when the shaft portion 2 (the rotating body 3) rotates, two regions (the upper and lower regions in which the dynamic pressure generating grooves 8a1 and 8a2, respectively, are formed) serving as the radial bearing surface of the inner peripheral surface 8a of the bearing sleeve 8 face to the outer peripheral surface 2a of the shaft portion 2 through the radial bearing gap. With the rotation of the shaft portion 2, the lubrication oil in the abovementioned radial bearing gap is pressed to axial center parts of the dynamic pressure generating grooves 8a1 and 8a2 to increase the pressure therein. Each of a first radial bearing portion R1 and a second radial bearing portion R2 is constituted through such dynamic pressure action of the dynamic pressure generating grooves 8a1 and 8a2 and radially supports the rotating body 3 in a non-contact manner.

At the same time, by the dynamic pressure action of the dynamic pressure generating grooves, an oil film of the lubricating oil is formed in the thrust bearing gap between a region (the region in which the dynamic pressure generating grooves 7a1 are formed) serving as a thrust bearing surface of the upper end surface 7a of the housing 7 and the lower end surface 9a1 of the disk portion 9a of the hub portion 9 which surface faces the above region. In addition, an oil film of the lubricating oil is also formed in the thrust bearing gap between the lower end surface 8c (the dynamic groove-formed region) of the bearing sleeve 8 and the upper end surface 20a of the flange portion 20 which surface faces to the lower end surface 8c. Each of the first thrust bearing portion T1 and the second thrust bearing portion T2 is constituted through the pressure of the oil film and supports in a non-contact manner the rotating body 3 in a thrust direction.

In the present invention, the lubricating oil is filled into each of the radial bearing gap, the thrust bearing gap of the second thrust bearing portion T2, the gap between an upper end surface 8d of the bearing sleeve 8 and the lower end surface 9a1 of the disk portion 9a of the hub portion 9, and a circulation groove 11. In this case, when the lubrication oil is allowed to circulate so as to successively pass through each of the gaps (including the circulation groove 11), disruption of the balance of the pressure in each of the gaps is prevented, and thus the occurrence of negative pressure can be prevented as much as possible. In FIG. 3, as means for generating such a circulating flow, a structure is exemplified in which, in the dynamic pressure generating grooves 8a1 serving as a dynamic pressure generating portion of the first radial bearing portion R1, the axial dimension X of an upper region is made larger than the axial dimension Y of a lower region. In this manner, the difference in pumping force between the upper region and the lower region is provided. In this case, the lubricating oil can be circulated in the following order: the radial bearing gap, the thrust bearing gap of the second thrust bearing portion T2, the circulation groove 11, and the gap between the upper end surface 8d of the bearing sleeve 8 and the lower end surface 9a1 of the disk portion 9a of the hub portion 9. The circulation direction of the lubricating oil may be opposite to the above direction. Furthermore, the pumping force difference between the upper and lower regions is not necessarily provided to the dynamic pressure generating grooves, if not particularly necessary.

The embodiment of the present invention has been described as above, but the invention is not limited to this embodiment.

FIG. 5 illustrates a fluid dynamic bearing device 101 according to a second embodiment of the present invention. This fluid dynamic bearing device 101 is different from that of the abovementioned first embodiment in that the shaft portion 2 and the hub portion 9 are integrally molded from resin and that a housing 107 is formed of resin. According to this configuration, surfaces facing through the thrust bearing gap in the first thrust bearing portion T1 are formed of resin. That is, each of an upper end surface 107a of the housing 107 and the lower end surface 9a1 of the disk portion 9a of the hub portion 9 is formed of resin. Since contact sliding occurs between these surfaces upon starting and stopping a motor or in other situations, these surfaces must be formed of a resin material having high wear resistance.

In view of the above, based on verification results obtained by the inventors and described later, sufficient wear resistance against contact sliding can be obtained by forming both the housing 107 and the hub portion 9 from a resin composition in which polyphenylene sulfide (PPS) is employed as a base resin. The filling amount of carbon fibers mixed in this resin composition is 10 to 35 vol % and more preferably 15 to 25 vol %. This is because, when the filling amount of the carbon fibers is less than 10 vol %, the reinforcing effects and the static electricity removal effects due to the carbon fibers are not exerted satisfactorily, and the wear resistance in sliding portions of the housing 107 and the hub portion 9 is not ensured. In addition, when the filling amount exceeds 35 vol %, the moldability of the housing 107 and the hub portion 9 deteriorates, and thus a difficulty arises in obtaining high dimensional accuracy. The other conditions for the resin composition are the same as those of the hub portion 9 of the abovementioned fluid dynamic bearing device 1, and thus the description thereof will be omitted.

FIG. 6 illustrates a fluid dynamic bearing device 201 according to a third embodiment of the present invention. In this embodiment, a shaft member 202 serving as the rotating body 3 has a complex structure composed of a shaft portion 202a formed of a metal material and a flange portion 202b made of a resin material and formed in the lower end of the shaft portion 202a. The stationary body 6 is composed of a housing 207, a bearing sleeve 208 fixed to the inner periphery of the housing 207, and a lid member 210 sealing a lower opening of the housing 207. In the upper end portion of the housing 207, a sealing portion 213 projecting toward the inner periphery is integrally formed. On an upper end surface 210a of the lid member 210, a region is formed in which, for example, a plurality of pressure grooves are arranged in a spiral shape. In addition to this, on a lower end surface 208c of the bearing sleeve 208, a region is formed in which pressure grooves are arranged in a shape the same as above. Here, these regions will not be illustrated. When the shaft member 202 rotates, a first thrust bearing portion T11 is formed between the lower end surface 208c of the bearing sleeve 208 and an upper end surface 202b1 of the flange portion 202b of the shaft member 202, and a second thrust bearing portion T12 is formed between the upper end surface 210a of the lid member 210 and a lower end surface 202b2 of the flange portion 202b. Here, the flange portion 202b may be formed only of resin and may have a complex structure formed by coating resin on a core metal.

In this embodiment, both the flange portion 202b of the shaft member 202 and the lid member 210 are formed of a resin composition in which PPS is employed as a base resin. In this manner, the cost and weight of the fluid dynamic bearing device 201 can be reduced. Furthermore, the lid member 210 and the flange portion 202b facing to each other through the thrust bearing gap in the second thrust bearing portion 12 can have excellent wear resistance, and thus the wear of both the members due to contact sliding upon starting and stopping a motor or in other situations can be suppressed.

FIG. 7 illustrates a fluid dynamic bearing device 301 according to a fourth embodiment of the present invention. In this embodiment, a housing 307 and a sealing portion 313 which constitute the stationary body 6 are formed separately. The sealing portion 313 is fixed to the inner periphery of the upper end of the housing 307 through means such as bonding, press-fitting, or welding. Furthermore, a lid member 310 is molded integrally with the housing 307 from a resin material. Both the lid member 310 and the flange portion 302b of the shaft member 302 are formed of a resin composition in which PPS is employed as a base resin. Since the effects of this embodiment and the configurations other than that described above are similar to those of the third embodiment, the description thereof will be omitted.

In the embodiments above, the description has been given of the case in which the housing 7 is formed separately from the bearing sleeve 8 accommodated within the housing 7. However, the housing 7 and the bearing sleeve 8 may be integrally formed from resin (the same may be applied to the housings 107, 207, and 307). FIG. 8 illustrates a fluid dynamic bearing device 401 according to a fifth embodiment of the present invention. The fluid dynamic bearing device 401 has a configuration different from that of the fluid dynamic bearing devices according to the abovementioned embodiments in that a bearing sleeve 408 and a housing 407 are integrally formed and that this integral body constitutes the stationary body 6. In this case, a radial bearing gap is formed between an inner peripheral surface 408a of the bearing sleeve 408 and the outer peripheral surface 2a of the shaft portion 2. Furthermore, a first thrust bearing gap is formed between an upper end surface 407a of the housing 407 and the lower end surface 9a1 of the disk portion 9a of the hub portion 9. In addition to this, a second thrust bearing gap is formed between a lower end surface 408b of the bearing sleeve 408 and the upper end surface 20a of the flange portion 20 of the shaft portion 2. Moreover, the circulation groove 11 comprises through holes passing through the bearing sleeve 408 and having an opening on an upper end surface 408d and on the lower end surface 408b. Since the configurations other than that described above are similar to those of the first embodiment, the description thereof will be omitted.

In this embodiment, by forming both the housing 407 and the hub portion 9 from a resin composition in which PPS is employed as a base resin, the cost and weight can be reduced. In addition, since the members facing to each other through the first thrust bearing gap and the radial bearing gap have excellent wear resistance, the wear of each of the members due to contact sliding can be suppressed.

In the embodiments above, the case in which the carbon fibers are mixed as a filler has been exemplified. However, inorganic materials such as metal fibers, glass fibers, and whiskers may be added in addition to the carbon fibers so long as the characteristics required for an application to be used are satisfied. For example, polytetrafluoroethylene (PTFE) can be mixed as a release agent having excellent oil resistance, and carbon black can be mixed as an electric conducting agent.

In the fluid dynamic bearing device 1 according to the first embodiment (see FIG. 2), the fluid dynamic bearing device 101 according to the second embodiment (see FIG. 5), and the fluid dynamic bearing device 401 according to the fifth embodiment (see FIG. 8), the description has been given of the case of providing the thrust bearing surface formed by arranging a plurality of the dynamic pressure grooves on the upper end surface of the housing (the first thrust bearing portion T1) and of providing the thrust bearing surface formed by arranging a plurality of the dynamic pressure grooves on the lower end surface of the bearing sleeve (the second thrust bearing portion T1). However, the present invention is similarly applicable to a fluid dynamic bearing device to which only the first thrust bearing portion T1 is provided. In this case, the shaft portion 2 may be formed into a straight shape without the flange portion 20. In addition to this, by forming the housing 7 from a resin material integrally with the lid member 10 serving as a bottom portion, the housing 7 may be formed into a closed-end cylindrical shape.

In the above embodiments, the configurations have been exemplified in which the dynamic pressure action of the lubricating fluid is generated through the dynamic pressure generating grooves having a herringbone shape or a spiral shape and serving as the radial bearing portions R1 and R2 or the thrust bearing portions T1 and T2. However, the present invention is not limited to these configurations.

For example, as the radial bearing portions R1 and R2, a so-called multilobe bearing may be employed, which will not be illustrated. In the multilobe bearing, so-called step-like dynamic pressure generating portions are formed by forming axial grooves in a plurality of locations along the circumferential direction. Alternatively, a plurality of arc-shaped surfaces are arranged along the circumferential direction to form wedge-shaped axial gaps (bearing gaps) between the arc-shaped surfaces and the outer peripheral surface 2a of the shaft portion 2 to which the respective arc-shaped surfaces face.

Alternatively, the inner peripheral surface 8a of the bearing sleeve 8 which surface serves as the radial bearing surface may be formed into a perfect circular inner peripheral surface not provided with the dynamic pressure generating grooves and the arc-shaped surfaces serving as the dynamic pressure generating portion. In this manner, a so-called cylindrical bearing may be constituted by this inner peripheral surface and the perfect circular outer peripheral surface 2a of the shaft portion 2 facing to the inner peripheral surface.

Moreover, one or both of the thrust bearing portions T1 and T2 may be constituted by a so-called step bearing, a wave-shaped bearing (in which a step shape is replaced with a wave shape), or the like, which will also not be illustrated. In the step bearing, a plurality of dynamic pressure generating grooves having a radial groove shape are provided in a region serving as a thrust bearing surface at regular intervals along the circumferential direction.

Furthermore, in the above embodiments, the description has been given of the case in which the radial bearing surface and the thrust bearing surface are formed in the side of the stationary body. However, the bearing surface in which these dynamic pressure generating portions are formed is not limited to the surface on the stationary body side and may be provided on the rotating body side facing to the stationary body.

### Example 1

In order to clarify the usefulness of the present invention, hub portion simulation test pieces were prepared by use of a plurality of resin compositions having different compositions to evaluate the characteristics required for a hub portion (a rotating body) for a fluid dynamic bearing device. The material compositions of the resin compositions are shown in FIGS. 9 and 10.

The raw materials employed in the resin compositions are listed as follows.

### (a) Type of Base Resins and Melt Viscosity

Linear type PPS: product of DAINIPPON INK AND CHEMICALS, INCORPORTED, grade; LC-5G, (melting temperature: 310° C., melt viscosity at a share rate of 10³ s⁻¹:280 Pa·s)

Crosslinked type PPS (1): product of DAINIPPON INK AND CHEMICALS, INCORPORTED, grade; T-4 (melting temperature: 310° C., melt viscosity at a share rate of 10³ s⁻¹:100 Pa·s)

Crosslinked type PPS (2): product of DAINIPPON INK AND CHEMICALS, INCORPORTED, grade; MB-600 (melting temperature: 310° C., melt viscosity at a share rate of 10³ s⁻¹:70 Pa·s)

Polyether sulfone (PES): product of Sumitomo Chemical Co., Ltd., grade; 4100G

Polycarbonate (PC): product of Mitsubishi Engineering-Plastics Corporation, grade; S-2000

### (b) Filler (Carbon Fiber)

PAN-based carbon fibers: product of TOHO TENAX Co., Ltd., grade; HM35-C6S (fiber diameter: 7 μm, average fiber length: 6 mm, aspect ratio: 857, tensile strength: 3240 MPa)

Pitch-based carbon fibers: product of Mitsubishi Chemical Corporation, grade; K223NM (fiber diameter: 10 μm, average fiber length: 6 mm, aspect ratio: 600, tensile strength: 2400 MPa)

### (c) Filler (Electric Conducting Agent)

Carbon black: product of Mitsubishi Chemical Corporation, grade; #3350B (particle diameter: 24 nm)

Ketjenblack: product of LION AKZO CO., LTD., grade; EC600JD (particle diameter: 34 nm)

### (d) Filler (Inorganic Material)

ALBOREX: product of SHIKOKU CHEMICALS CORPORATION, grade; Y (main component: aluminum borate, average diameter: 0.5 to 1 μm, average fiber length: 10 to 30 μm, aspect ratio: 10 to 60)

TISMO: product of OTSUKA Chemical Co., Ltd., grade; N (main component: potassium titanate, average diameter: 0.3 to 0.6 μm, average fiber length: 10 to 20 μm, aspect ratio: 16 to 66)

### (e) Filler (Release Agent)

PTFE: product of KITAMURA Ltd., grade; KTL-620

The rotating body simulation test pieces were evaluated for the following six evaluation items: (1) wear resistance, (2) conductivity, (3) non-dissolving characteristics of ions, (4) tensile strength, (5) flatness, and (6) linear expansion coefficient. The evaluation method and the acceptance/rejection criteria for each of the evaluation items are listed as follows.

### (1) Wear Resistance

Ring-shaped test samples formed from different respective materials having the compositions shown in FIGS. 9 and 10 were subjected to a ring-on-disk test for measurement. In the ring-on-disk test, the ring-shaped sample was pressed on a disk-shaped partner material for sliding in a lubricating oil at a predetermined load, and the disk part was rotated while the above state was maintained. Specifically, a ring-shaped resin-molded body of φ21 mm (outer diameter)×φ17 mm (inner diameter)×3 mm (thickness) was employed as the test sample. Furthermore, a disk material (surface roughness Ra: 0.04 μm, φ30 mm (diameter)×5 mm (thickness), made of SUS 420) was employed for the partner material for sliding. As the lubricating oil, a diester oil (di(2-ethylhexyl) azelate) was employed. The kinetic viscosity of this lubricating oil is 10.7 mm²/s at 40° C. During the ring-on-disk test, the contact pressure of the partner material for sliding against the test sample was 0.25 MPa, and the rotation speed (the peripheral speed) was 1.4 mm/min. In addition to this, the test time was 14 h, and the oil temperature was 80° C. In the acceptance/rejection criteria, for the wear depth of the ring, the test sample was evaluated as being accepted (good) when the depth was 3 μm or less and as being rejected (failure) when the depth exceeds 3 μm. In addition, for the wear depth of the partner material for sliding, the partner material was evaluated as being accepted (good) when the depth was 2 μm or less and as being rejected (failure) when the depth exceeds 2 μm.

### (2) Conductivity

By use of test pieces formed from different respective materials having the compositions shown in FIGS. 9 and 10, the volume resistivity was measured by means of a four-point probe method according to JIS K 7194. In the acceptance/rejection criteria, the test piece was evaluated as being accepted (good) when the volume resistivity was 1.0×10⁶ Ω·cm or less and as being rejected (failure) when the volume resistivity exceeds 1.0×10⁶ Ω·cm.

### (3) Non-Dissolving Characteristics of Ions

The presence or absence of ion dissolution from the resin to a solvent was evaluated. In the evaluation method, the presence or absence of various ions dissolved from test pieces formed from different respective materials having the compositions shown in FIGS. 9 and 10 was confirmed by use of ion chromatography. Specific procedures are as follows.

(i) A predetermined amount of ultra pure water was poured into an empty beaker, and the abovementioned test piece was placed therein. Here, the surface of the test piece was sufficiently washed with ultra pure water in advance.
(ii) The above beaker was set in a thermostatic bath heated at 80° C. for one hour to allow ions contained in the surface and inside of the sample piece to dissolve in ultra pure water. On the other hand, a beaker which contained only ultra pure water and in which the test piece was not placed was similarly set in a thermostatic bath heated at 80° C. for one hour, and this ultra pure water was used as a blank.
(iii) The amount of ions contained in the ultra pure water which had been prepared above and in which the test piece had been placed was measured by means of ion chromatography (measured value A). Separately, the amount of ions contained in the blank was measured as above (measured value B).
(iv) The presence or absence of dissolution of ions was confirmed by subtracting the measured value B from the measured value A.

In the acceptance/rejection criteria, detection target ions were ions analyzable by means of a column generally employed in ion chromatography. The sample was evaluated as being accepted (good) when ions listed below were not detected, and as being rejected (failure) when the ions were detected.

### Detection Target Ions:

Cations: Li⁺, Mg²⁺, Na⁺, Ca²⁺, K⁺, Sr²⁺, Rb⁺, Ba²⁺, Cs⁺, NH₄⁺

Anions: F⁻, NO³⁻, Cl⁻, PO₄³⁻, NO²⁻, SO₄²⁻, Br⁻, SO₃²⁻

### (4) Tensile Strength

By use of dumbbells No. 1 stipulated under JIS K7113 and formed from different respective materials having the compositions shown in FIGS. 9 and 10, the tensile strength was evaluated at a stress rate of 10 mm/min. In the acceptance/rejection criteria, the sample was evaluated as being accepted (good) when the tensile strength was 100 MPa or more, and as being rejected (failure) when the tensile strength was less than 100 MPa.

### (5) Flatness

In the hub portions 9 made of resin and shown in the abovementioned embodiments, if the flatness of a molded surface, in particular the disk placing surface 9c, is low, unnecessary bending stresses are generated in a mounted disk and the smoothness of the disk surface deteriorates. This may adversely affect the read-write characteristics. Therefore, the resin composition forming the hub portion 9 must be molded with high flatness.

The evaluation method is given as follows. Drilled disk-shaped molded bodies having a side gate of a diameter of 1 mm provided in the side surface portion thereof and dimensions of φ10 mm (outer diameter)×φ7 mm (inner diameter)×2 mm (thickness) were injection molded from different respective materials having the compositions shown in FIGS. 9 and 10. These bodies served as a test piece for the flatness test. Each of the test pieces was placed on a turntable of TALYROND (product of Taylor Hobson Ltd.), and the flatness of the sample piece was measured by rotating 360° the test piece with which a probe was made contact on a measurement circle having a diameter of 8 mm. In the acceptance/rejection criteria, the test piece was evaluated as being accepted (good) when the flatness thereof was 10 μm or less, and as being rejected (failure) when the flatness exceeds 10 μm.

### (6) Linear Expansion Coefficient

The linear expansion coefficient of the resin compositions was measured by use of a TMA (a thermo-mechanical property analyzer). The evaluation method is given as follows.

(i) The gate portion of the test piece molded in (5) of the flatness evaluation test was cut, and the cut portion was polished with emery paper of # 2000.
(ii) The test piece was set in the TMA. For measuring the amount of thermal expansion in the diameter direction of the ring-shaped test piece, the test piece was set such that the measurement direction of the measurement probe was oriented along the diameter direction of the test piece.
(iii) The set test piece was measured for the amount of thermal expansion at a measurement load of 0.05 N, a measurement temperature range of 25° C. to 90° C., and a rate of temperature rise of 5° C./min under a nitrogen atmosphere, thereby computing the linear expansion coefficient. In this test, the linear expansion coefficient was measured in two directions, i.e., a diameter direction (MD) parallel to the direction of flow of resin at the time of molding the test piece and a diameter direction (TD) orthogonal to the flow direction.

The acceptance/rejection criteria were set under a limitation imposed by the insert member (A) and a limitation imposed by the disk (B). In this evaluation test, the raw material for the insert member (the shaft portion) was SUS420 (the linear expansion coefficient at 25° C. to 90° C.: 1.05×10⁻⁵° C.⁻¹), and the raw material for the disk was glass (the linear expansion coefficient at 25° C. to 90° C.: 0.65×10⁻⁶° C.⁻¹). In addition, the diameter gap between the hub portion and the disk in a cold state was 0.010 mm, and the outer diameter of the hub portion in a cold state was 5 mm. Furthermore, the employed temperature range was 25° C. to 90° C.

### (A) Limitation Imposed by the Insert Member:

If the linear expansion coefficient of the resin portion is set to four times or less the linear expansion coefficient of the insert member, peeling and displacement on the bonding surface between the hub portion and the insert member can be avoided. Therefore, the upper limit of the linear expansion coefficient of the resin composition due to the limitation imposed by the insert member is set to 4.2×10⁻⁵° C.⁻¹.

### (B) Limitation Imposed by the Disk:

In order to prevent the gap between the disk and the hub portion from being a negative gap when the temperature of use environment reaches maximum under the conditions of this evaluation test, the upper limit of the linear expansion coefficient of the resin composition is set to 3.7×10⁻⁵° C.⁻¹.

Under these two limitations, the acceptance/rejection criteria were set such that the test piece was evaluated as being accepted (good) when the linear expansion coefficient thereof was 3.7×10⁻⁵° C.⁻¹ or less, and as being rejected (failure) when the linear expansion coefficient thereof exceeded 3.7×10⁻⁵° C.⁻¹.

In FIG. 11, the acceptance/rejection criteria of the abovementioned tests are summarized. Furthermore, the test results are shown in FIGS. 12 and 13. As shown in the test results, the resin compositions of the Examples, in which PPS (the amount of dissolution of ions is small) is employed as the base resin and the appropriate amount of carbon fibers is mixed, satisfy all the evaluation criteria. Therefore, such resin compositions are suitable for a raw material for forming the hub portion.

### Example 2

In order to clarify the usefulness of the present invention, an evaluation test for the amount of wear for contact sliding between resin compositions was performed on a plurality of resin compositions having different compositions. As the base resin, linear type polyphenylene sulfide (PPS), crosslinked type polyphenylene sulfide (PPS), or a liquid crystal polymer (LCP) was employed. Four types of fillers were appropriately mixed with these base resins, and resin compositions of Reference Examples 1 to 7 shown in FIG. 14 were formed.

The raw materials employed in the resin compositions are listed as follows.

Linear type polyphenylene sulfide (PPS): product of DAINIPPON INK AND CHEMICALS, INCORPORTED, LC-5G (melting temperature: 310° C., melt viscosity at a share rate of 10³ s⁻¹:280 Pa·s)

Crosslinked type polyphenylene sulfide (PPS): product of DAINIPPON INK AND CHEMICALS, INCORPORTED, T-4 (melting temperature: 310° C., melt viscosity at a share rate of 10³ s⁻¹:100 Pa·s)

Liquid crystal polymer (LCP): product of Polyplastics Co., Ltd., A950 (melting temperature: 310° C., melt viscosity at a share rate of 10³ s⁻¹:40 Pa·s)

Carbon fiber (PAN-based): product of TOHO TENAX Co., Ltd., HM35-C6S (fiber diameter: 7 μm, average fiber length: 6 mm, tensile strength: 3240 MPa)

Electric conducting agent: Carbon black, product of Mitsubishi Chemical Corporation (grade; #3350B, average particle diameter: 24 nm)

Inorganic material: ALBOREX, product of SHIKOKU CHEMICALS CORPORATION, (grade: Y, main component: aluminum borate, average diameter: 0.5 to 1 μm, average fiber length: 10 to 30 μm, form: whisker)

Release agent: polytetrafluoroethylene, product of KITAMURA Ltd. (PTFE) (KTL-620)

Disk-shaped test samples serving as the stationary side member and ring-shaped test samples serving as the rotating side member were formed from different respective resin compositions having the mixing ratios shown in FIG. 14. The amount of wear of each of the samples against contact sliding was measured by means of a ring-on-disk test. In the ring-on-disk test, the ring-shaped sample was pressed on the disk-shaped test sample at a predetermined load, and the ring-shaped test sample was rotated under predetermined conditions with a lubrication oil intervening between the test samples. Subsequently, the depth of wear of each of the test samples was measured. Since the other test conditions and the acceptance/rejection criteria are the same as those in Example 1 above, the description thereof will be omitted.

The test results are shown in FIGS. 15 and 16. As in Comparative Examples 1 to 4 shown in FIG. 16, when the base resins of the resin compositions forming the ring-shaped test sample and the disk-shaped test sample are an LCP for both the samples, or when one of the base resins is an LCP and the other is PPS, the depth of wear for each of the samples exceeds the reference value. Therefore, for both the cases, the wear resistance for sliding wear is not considered to be sufficient. On the other hand, as in Examples 1 to 5 shown in FIG. 15, when the base resins of the resin compositions forming the ring-shaped test sample and the disk-shaped test sample are PPS for both the samples, the depth of wear of each of the members is below the reference value. Therefore, when a resin composition in which PPS is employed as the base resin is selected for each of the test samples which slide relative to each other, satisfactory wear resistance is obtained.

### BRIEF DESCRIPTION OF THE DRAWINGS

FIG. 1 is a cross-sectional view of a spindle motor into which a fluid dynamic bearing device 1 according to an embodiment of the present invention is incorporated.

FIG. 2 is a cross-sectional view of the fluid dynamic bearing device 1.

FIG. 3 is a cross-sectional view of a bearing sleeve 8.

FIG. 4 is an upper end view of a housing 7.

FIG. 5 is a cross-sectional view of a fluid dynamic bearing device 101.

FIG. 6 is a cross-sectional view of a fluid dynamic bearing device 201.

FIG. 7 is a cross-sectional view of a fluid dynamic bearing device 301.

FIG. 8 is a cross-sectional view of a fluid dynamic bearing device 401.

FIG. 9 is a drawing showing the material composition of resin compositions employed for Examples in Example 1.

FIG. 10 is a drawing showing the material composition of resin compositions employed for Comparative Examples in Example 1.

FIG. 11 is a drawing showing acceptance/rejection criteria for evaluation tests in Example 1.

FIG. 12 is a drawing showing test results for Examples in Example 1.

FIG. 13 is a drawing showing test results for Comparative Examples in Example 1.

FIG. 14 is a drawing showing the material composition of Reference Examples in Example 2.

FIG. 15 is a drawing showing the comparison test results of Examples in Example 2.

FIG. 16 is a drawing showing the comparison test results of Comparative Examples in Example 2.

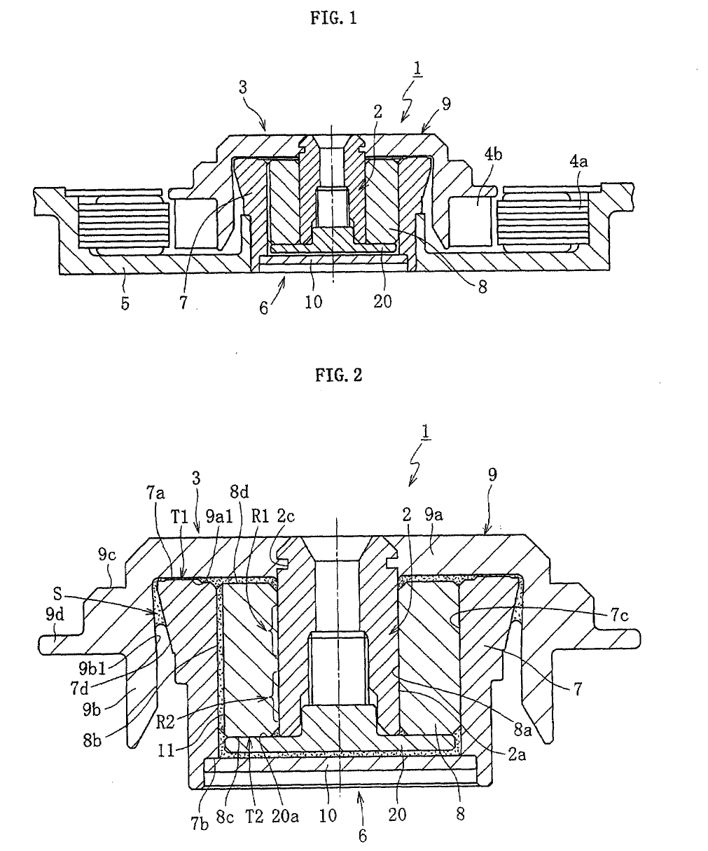

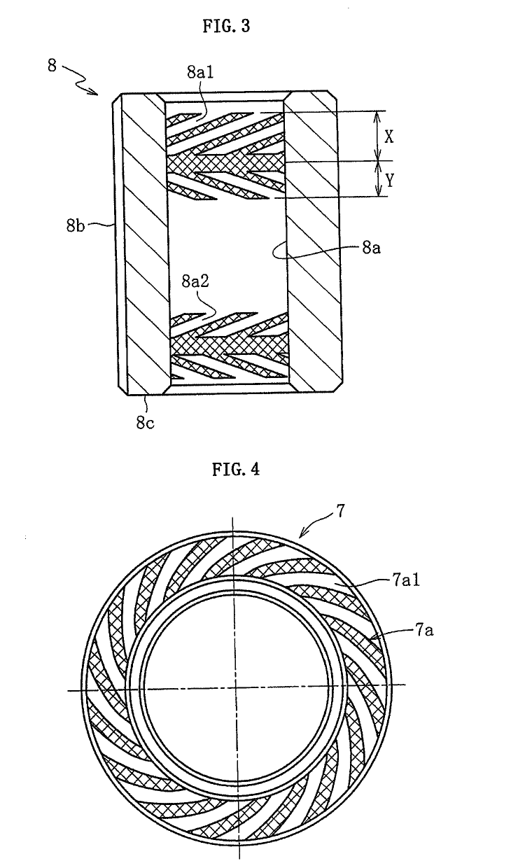

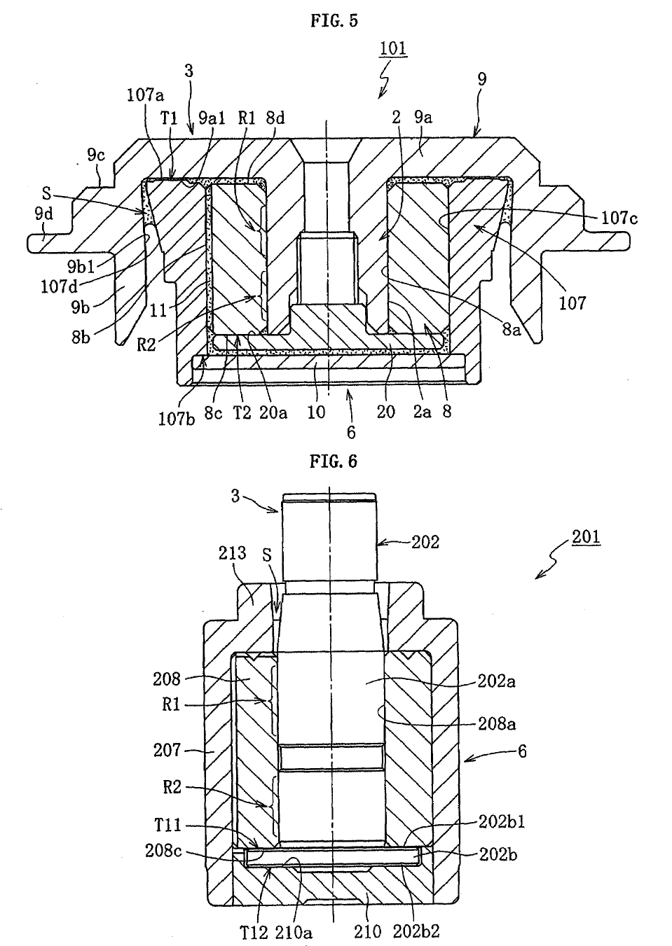

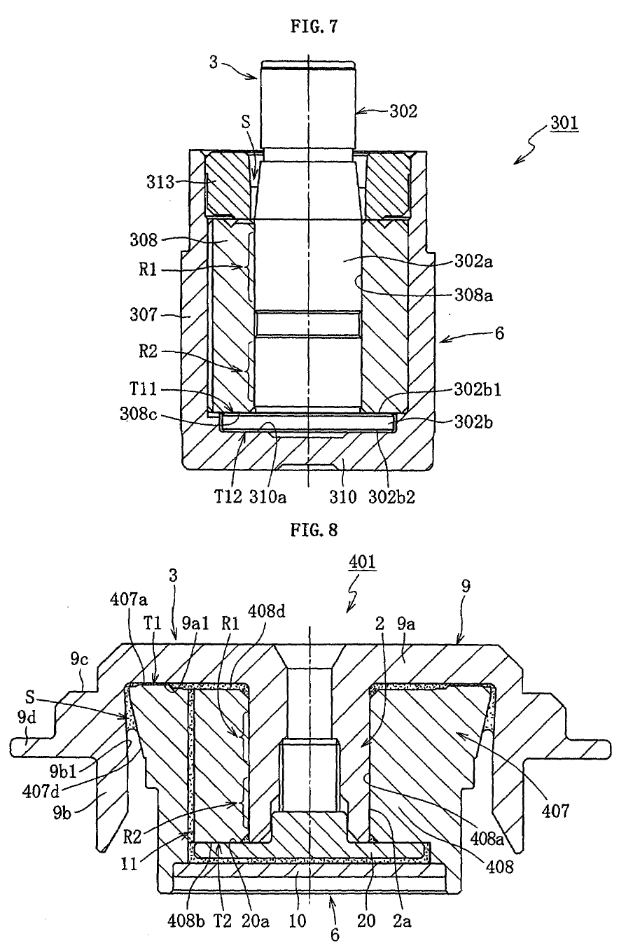

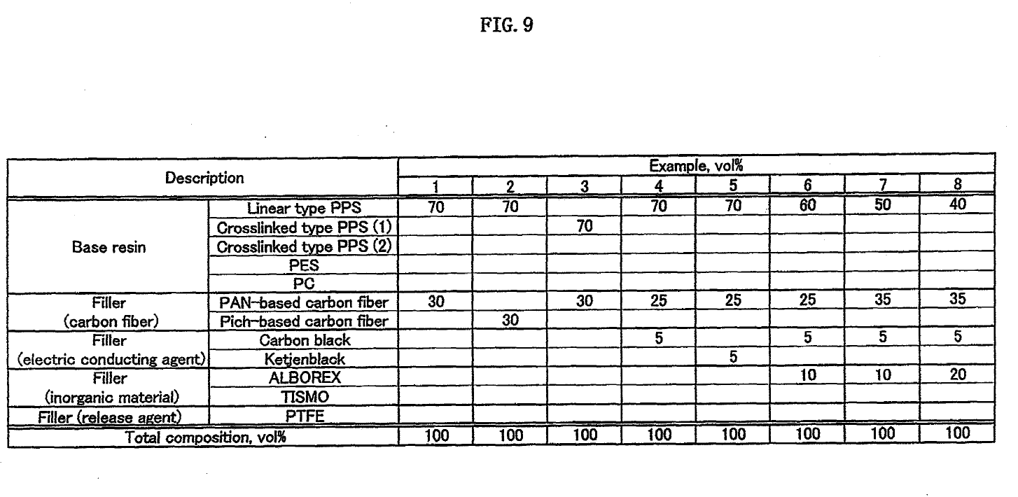

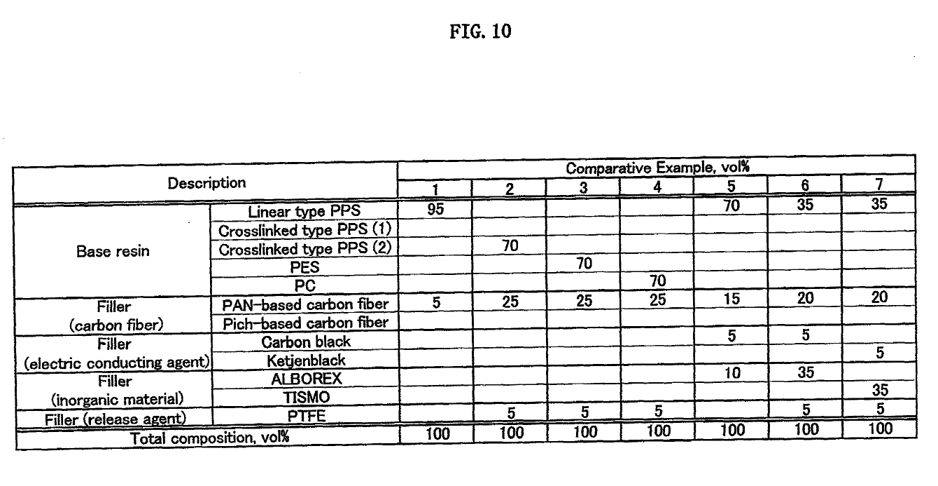

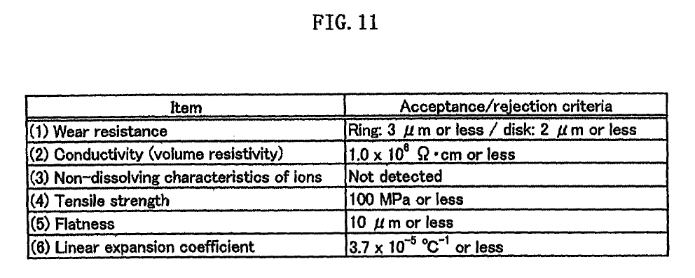

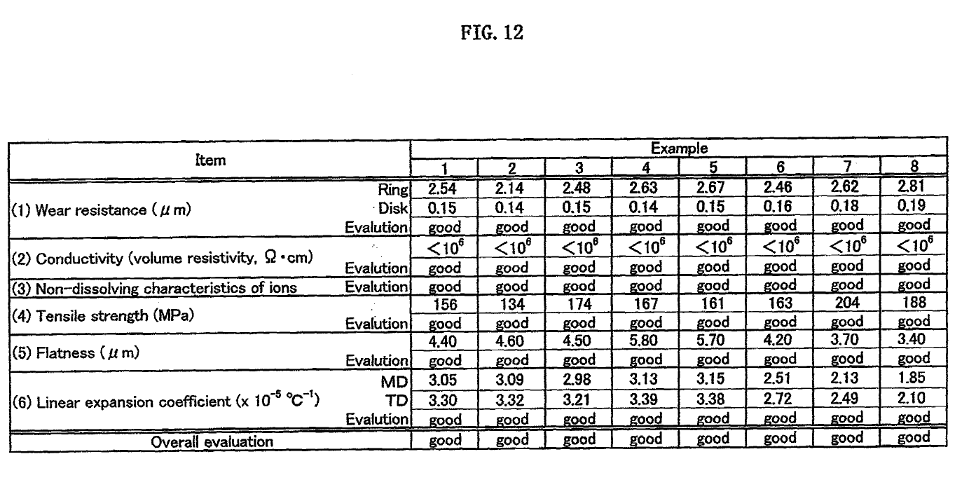

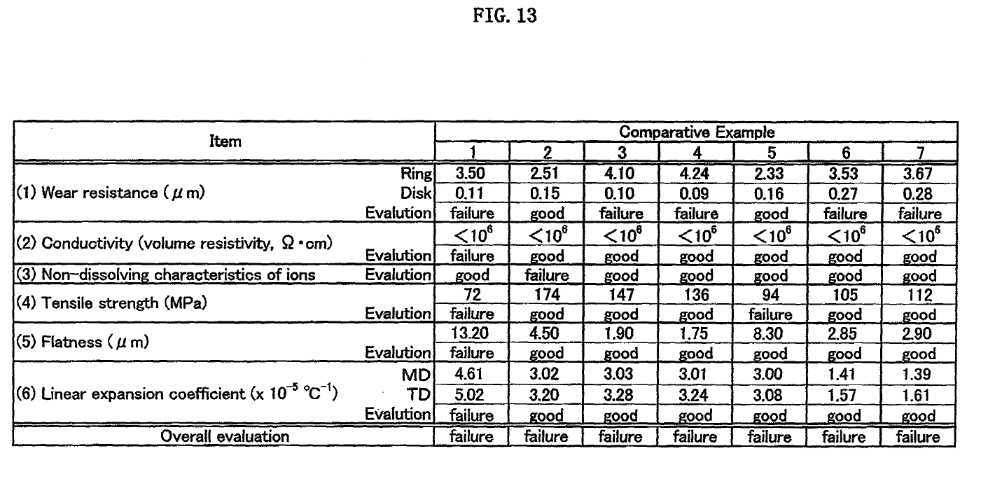

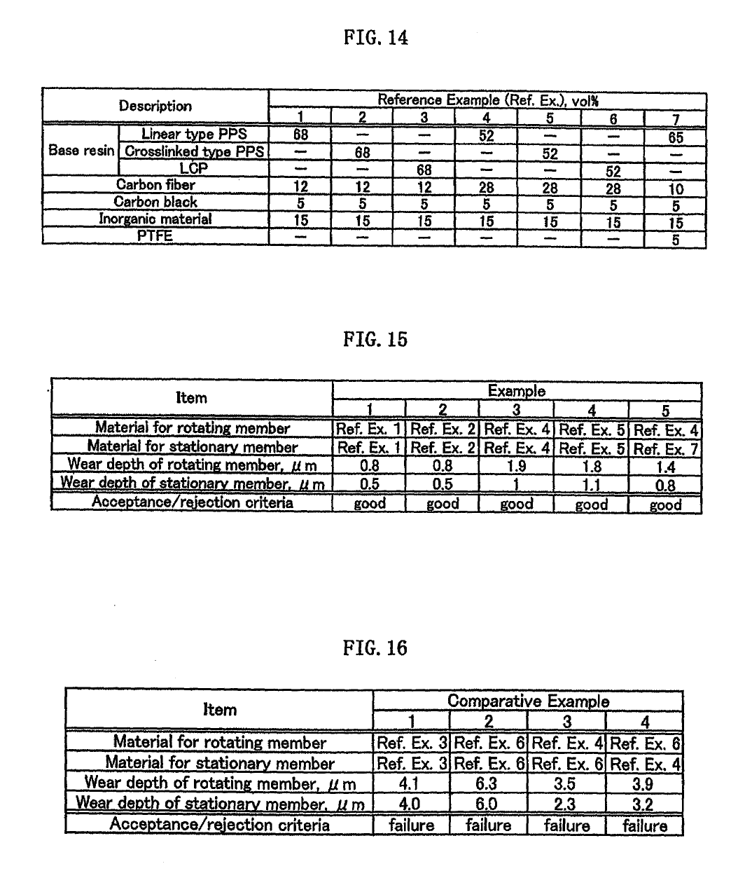

### EXPLANATION OF SYMBOLS

1 fluid dynamic bearing device
2 shaft portion
3 rotating body
4a stator coil
4b rotor magnet
5 motor bracket
6 stationary body
7 housing
8 bearing sleeve
9 hub portion
10 lid member
11 circulation groove
R1, R2 radial bearing portion
T1, T2 thrust bearing portion
S sealing space

1. A fluid dynamic bearing device comprising a rotating body having a shaft portion and a hub portion attached to the shaft portion integrally or separately and a stationary body having the shaft portion inserted thereinto, and wherein the rotating body is rotatably supported by an oil film formed in a bearing gap between the stationary body and the hub portion, and
wherein at least part of the hub portion which part faces to the bearing gap is formed from a resin composition in which polyphenylene sulfide (PPS) is employed as a base resin and with which carbon fibers serving as a filler are mixed.

2. A fluid dynamic bearing device according to claim 1, wherein the carbon fibers are contained in the resin composition in an amount of 20 to 35 vol %.

3. A fluid dynamic bearing device having a rotating body, a stationary body, and an oil film
which is formed in a bearing gap between the rotating body and the stationary body and
which supports the rotating body so as that the rotating body can rotate freely, and wherein
at least parts of the rotating body and the stationary body which parts face to each other through the bearing gap are formed from a resin composition including PPS serving as a base resin.

4. A fluid dynamic bearing device according to claim 3, wherein the resin composition contains carbon fibers.

5. A fluid dynamic bearing device according to claim 4, wherein the carbon fibers are contained in the resin composition in an amount of 10 to 35 vol %.

6. A fluid dynamic bearing device according to claim 1, wherein the carbon fiber is PAN-based carbon fiber.

7. A fluid dynamic bearing device according to claim 4, wherein the carbon fiber has an aspect ratio of 6.5 or more.

8. A motor having a fluid dynamic bearing device according to claim 1, a rotor magnet, and a stator coil.

9. A fluid dynamic bearing device according to claim 4, wherein the carbon fiber is PAN-based carbon fiber.
